(19) United States
(12) Patent Application Publication
(10) Pub. No.: US 2019/0304444 A1
(43) Pub. Date: Oct. 3, 2019

(54) HANDS-FREE RECORDING DEVICE COMMUNICABLE WITH A MOBILE DEVICE

(71) Applicant: Tiana Cook, Marylhurst, OR (US)

(72) Inventor: Tiana Cook, Marylhurst, OR (US)

(21) Appl. No.: 15/942,491

(22) Filed: Mar. 31, 2018

(51) Int. Cl. G10L 15/22

(52) U.S. Cl. CPC G10L 15/22; G10L 2015/223

(57) ABSTRACT

A hands-free recording device to communicate with a mobile device, the hands-free recording device including a body, a microphone disposed on a surface the body to receive a voice command from a user to initiate recording of an audio file including subsequent words spoken by the user, wherein the audio file is transmitted to the mobile device after the recording of the audio file ceases.

### BACKGROUND

### 1. Field

The present general inventive concept relates generally to a recording device, and particularly, to a hands-free recording device communicable with a mobile device.

### 2. Description of the Related Art

Many caregivers, such as teachers, baby-sitters or even conscientious parents, may desire to document daily activities of a child in order to track their development and health of the child. Currently, individuals must annotate such information using writing implements and paper, which may be impractical, as it is easily forgettable to log each event, especially during busy moments or when handling and monitoring multiple children.

Therefore, there is a need for a device that allows hands-free recording and storing of recorded audio files.

### SUMMARY

The present general inventive concept provides a hands-free recording device communicable with a mobile device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hands-free recording device to communicate with a mobile device, the hands-free recording device including a body, a microphone disposed on a surface the body to receive a voice command from a user to initiate recording of an audio file including subsequent words spoken by the user, wherein the audio file is transmitted to the mobile device after the recording of the audio file ceases.

The recording of the audio file may cease in response to another voice command.

The body may include a personalized picture disposed on a front surface of the body.

The body may include a clip disposed on a rear surface of the body to allow the hands-free recording device to be clipped onto at least one of a shirt, a belt, and pants of the user.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a hands-free recording device, according to an exemplary embodiment of the present general inventive concept; and

FIG. 2 illustrates a rear perspective view of the hands-free recording device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

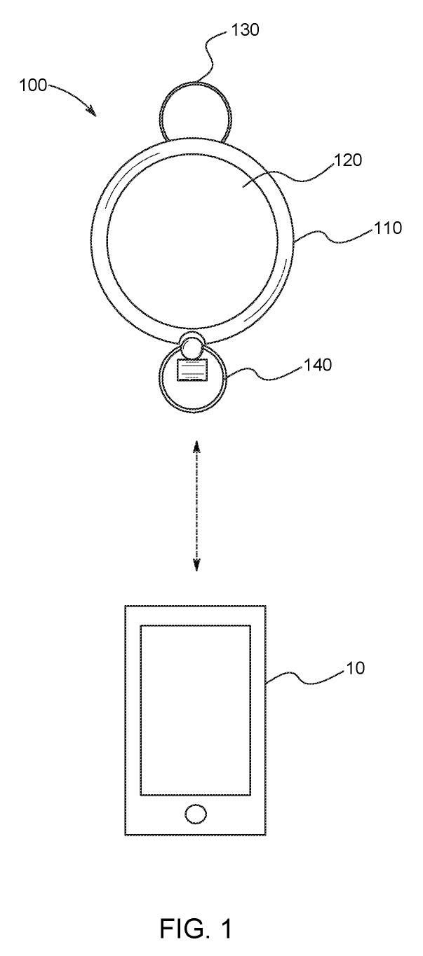

FIG. 1 illustrates a front perspective view of a hands-free recording device 100, according to an exemplary embodiment of the present general inventive concept.

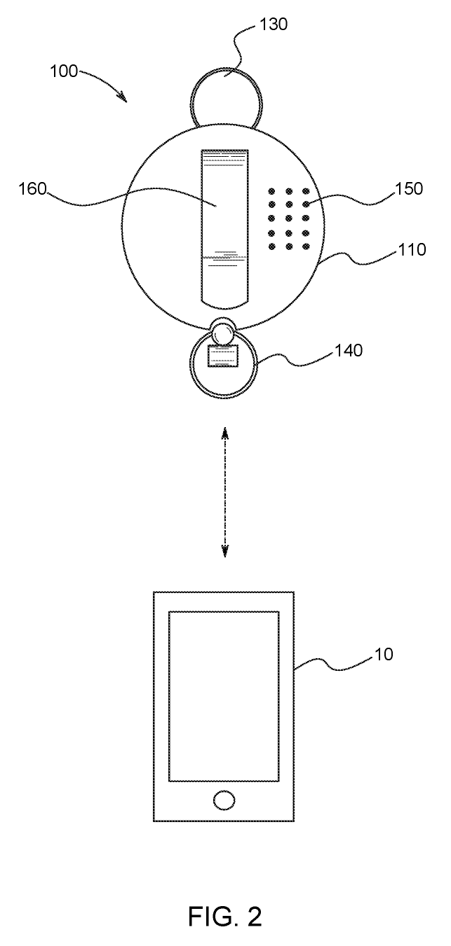

FIG. 2 illustrates a rear perspective view of the hands-free recording device 100, according to an exemplary embodiment of the present general inventive concept.

Referring to FIGS. 1 and 2, the hands-free recording device 100 may include an inner processor having a storage unit, a sensor, and a communication unit to communicate wirelessly with a mobile device 10, which may include a mobile phone, a computer, or a portable computing device. Wireless communications may include Internet connectivity, BLUETOOTH pairing, near field communications, RFID, WIFI, etc., but is not limited thereto.

The hands-free recording device 100 may include a body 110, a personalized picture 120, a keychain ring 130, a key ring 140, a microphone 150, and a clip 160.

The body 110 may be constructed from plastic, paper, metal, rubber, wood, silicone, glass, or any other material known to one of ordinary skill in the art, and may be round, rectangular, or any other shape known to one of ordinary skill in the art.

The personalized picture 120 may be disposed on a front surface of the body 110, and may include any picture, photo, or illustration desired by a user.

The keychain ring 130 may be a ring disposed at a top portion of the body 110, which may be attached to a keychain.

The key ring 140 may be a ring disposed at a bottom portion of the body 110, which may allow keys to be attached thereto.

Referring to FIG. 2, the microphone 150 may be disposed at a rear surface of the body 110, but is not limited thereto, and may be provided at any surface of the body 110.

The microphone 150 may be connected to the processor and/or the sensor stored within the body 110, which may allow a user to record an audio file based on a predetermined voice command.

More specifically, if the user desires to begin recording a message, the user may speak a predetermined word or phrase (i.e., a command) to activate the recording. The microphone 150 will receive the spoken command, and the sensor within the body 110 may sense the spoken command, such that the processor controls the storage unit to begin audio-recording subsequent words or phrases. Once the desires words or phrases have been recorded, the user may state another command to end the recording. Alternatively, the recording may be stopped if the user stops speaking for a predetermined time period. Also, the user may transmit the recorded audio file from the hands-free recording device 100 via the communication unit to the mobile device 10, which may have an application or software running thereon to allow the user to view, arrange, and/or listen to the transmitted audio files. The transmission of the audio file from the hands-free recording device 100 to the mobile device 10 may be initiated via a voice command from the user, or alternatively, when the hands-free recording device 100 is brought within proximity of the mobile device 10.

As such, when the user is taking care of a child and desires to quickly record a bowel movement, a feeding time, a health condition, etc., of the child, the user may speak a voice command, such as “Start Recording,” which causes the hands-free recording device 100 to initiate recording of subsequent phrases. After the subsequent phrases are spoken, the user may speak another voice command, such as “End Recording,” which causes the hands-free recording device 100 to stop the recording, generate an audio file, and send (i.e., transmit) the audio file to the mobile device 10.

The clip 160 may be disposed on the rear surface of the body 110, and may allow the user to clip the hands-free recording device 100 to a shirt, pants, or belt of the user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. CLAIMS

1. A hands-free recording device to communicate with a mobile device, the hands-free recording device comprising:
a body; and
a microphone disposed on a surface of the body to receive a voice command from a user to initiate recording of an audio file including subsequent words spoken by the user, wherein the audio file is transmitted to the mobile device after the recording of the audio file ceases.

2. The hands-free recording device of claim 1, wherein the recording of the audio file ceases in response to another voice command.

3. The hands-free recording device of claim 1, wherein the body comprises:
a personalized picture disposed on a front surface of the body.

4. The hands-free recording device of claim 1, wherein the body comprises:
a clip disposed on a rear surface of the body to allow the hands-free recording device to be clipped onto at least one of a shirt, a belt, and pants of the user.
